(19) United States
(12) Patent Application Publication
(10) Pub. No.: US 2006/0098530 A1
(43) Pub. Date: May 11, 2006

(54) Directional transducers for use in down hole communications

(75) Inventors: Edgar R. Mallison, Wayzata, MN (US); Thomas G. Stratton, Roseville, MN (US)

Correspondence Address: HONEYWELL INTERNATIONAL INC., 101 COLUMBIA ROAD, P O BOX 2245, MORRISTOWN, NJ, 07962-2245, US

(73) Assignee: Honeywell International Inc.

(21) Appl. No.: 10/975,212

(22) Filed: Oct. 28, 2004

(51) Int. Cl. H04H 9/00

(52) U.S. Cl. 367/81

(57) ABSTRACT

A communication device associated with a well has a transducer and a controller. The transducer is part of a first communication device and converts a signal between an electrical form and an acoustic form. The controller controls the transducer so that the transducer has a preferred directionality with respect to an acoustic signal transmitted between the first communication device and a second communication device. The transducer includes a plurality of electrical/acoustic converters, such as piezoelectric devices, and one or more of the electrical/acoustic converters are controlled so that the transducer has the preferred directionality.

### TECHNICAL FIELD OF THE INVENTION

The present invention relates to transducers that are used to directionally communicate acoustic messages through wells.

### BACKGROUND OF THE INVENTION

The control of oil and/or gas production wells has become increasingly complex. Wells under the control of a single company are being drilled throughout the world. Therefore, the need for central control of wells that are widely dispersed geographically presents challenges to the communication of sensor and logging information from the wells to the central controller and to the communication of control information from the central controller to the wells.

Moreover, the wells themselves have become increasingly more complex. For example, well holes are being drilled with multiple branches and are being divided into multiple production zones that discretely produce fluid in either common or discrete production tubing. As a result, the importance of communications between zones of a well, between the well and the surface, and between wells has increased.

As a consequence, it is known to position sophisticated computer and telecommunication equipment at the surface of wells and within the wells for supporting the communication of sensor, logging, and control information. The equipment within the well hole has usually been hardwired together and to the equipment at the surface. Often, the wires are run through the well in conduits or cement casings that can crack from forces in the well. When the conduits or casings crack, the wires break, thereby terminating communications through these wires until they are repaired.

Signals have also been acoustically communicated between this equipment. In this case, the information and control signals may be acoustically communicated at variable frequencies, at specific fixed frequencies, and/or using codes. Also, such acoustic signals may be transmitted through casing streams, electrical lines, slick lines, subterranean soil, tubing fluid, and/or annulus fluid.

Transmitters that convert electrical signals to acoustic signals are used to transmit the acoustic signals, and receivers that convert the acoustic signals back to electrical signals are used to receive the acoustic signals. These transmitters and receivers typically include transducers, such as piezoelectric transducers, to perform the required conversions. Piezoelectric transducers generate a mechanical force when alternating current voltage is applied thereto. The signal generated by the stressing of the piezoelectric transducers travels along the borehole between transmitters and receivers that are situated at the various sensing and control locations along the well and at the surface.

When acoustic signals are used to communicate sensor, logging, and control information through a well, various acoustic signal impairments, such as echoes, flow and machine noise, and reverberations, can interfere with the accurate recovery of the sensor, logging, and/or control information from the acoustic signals. Accordingly, the environment of such acoustic communication systems is very noisy, making the effective communication of messages between a transmitter and a receiver difficult to achieve.

Furthermore, communication equipment presently used to communicate messages within the well and between the well and surface is expensive and requires substantial maintenance.

The present invention addresses one or more of these or other problems by providing directional transducers in a down hole communication system.

### SUMMARY OF THE INVENTION

In accordance with one aspect of the present invention, a communication device associated with a well comprises a transducer and a controller. The transducer converts an electrical signal to an acoustic signal. The controller is coupled to the transducer and controls the transducer so as to steer the acoustic signal through the well toward a receiving device.

In accordance with another aspect of the present invention, a communication device associated with a well comprises a transducer and a controller. The transducer receives an acoustic signal transmitted by a transmitting device and converts the received acoustic signal to an electrical signal. The controller is coupled to the transducer and controls the transducer so that the transducer has a preferred directional sensitivity to the received acoustic signal.

In accordance with still another aspect of the present invention, a communication method comprises the following: converting a signal between an electrical form and an acoustic form, wherein the converting is performed by a transducer of a first communication device; and, controlling the transducer so that the transducer has a preferred directionality with respect to an acoustic signal transmitted between the first communication device and a second communication device.

### BRIEF DESCRIPTION OF THE DRAWINGS

These and other features and advantages will become more apparent from a detailed consideration of the invention when taken in conjunction with the drawings in which:

FIG. 1 illustrates a monitoring and control system in accordance with one embodiment of the present invention;

FIG. 2 illustrates a representative one of the surface monitoring and control systems shown in FIG. 1;

FIG. 3 illustrates a representative one of the down hole monitoring and control systems shown in FIG. 1;

FIG. 4 is a perspective view of a transducer that can be used in connection with the surface monitoring and control system of FIG. 2 and the down hole monitoring and control system of FIG. 3; and,

FIG. 5 is a cross-sectional view of the transducer shown in FIG. 4.

### DETAILED DESCRIPTION

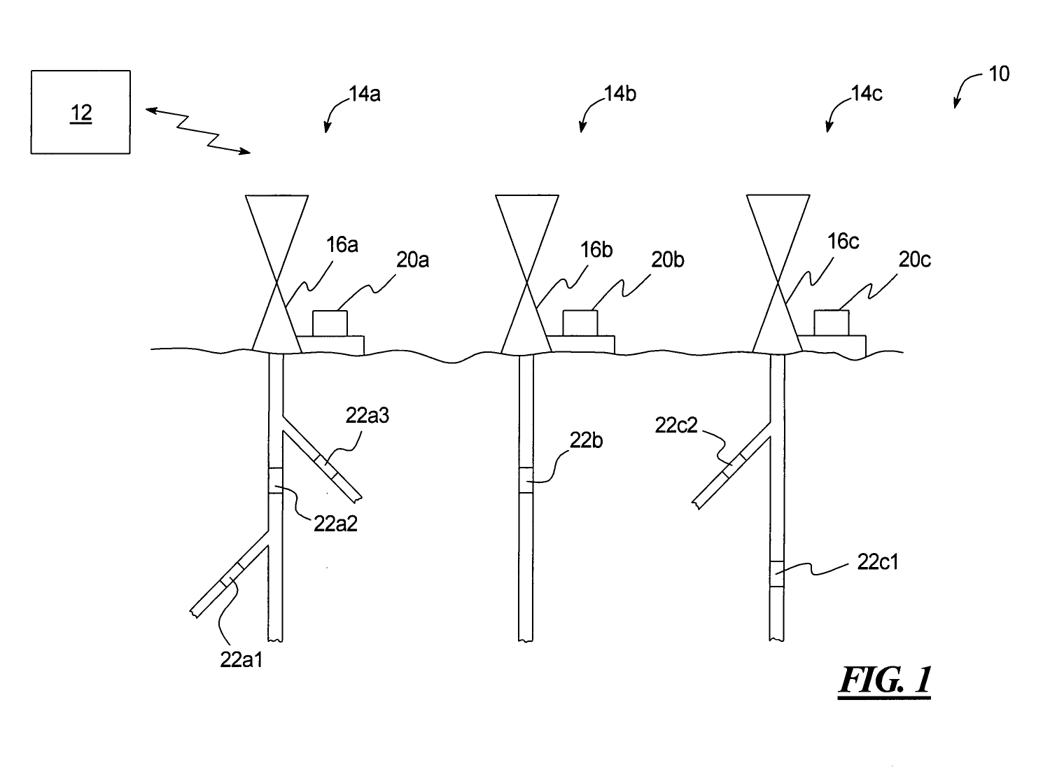

As shown in FIG. 1, a monitoring and control system 10 includes a remote central control center 12 that communicates with a plurality of wells 14a, 14b, and 14c. Although only three wells are shown in FIG. 1, it should be understood that the monitoring and control system 10 may include any number of wells. Because the wells 14a, 14b, and 14c may be geographically dispersed, the remote central control center 12 may communicate with the wells 14a, 14b, and 14c using cellular transmissions, satellite transmissions, telephone lines, and/or the like.

Each of the wells 14a, 14b, and 14c is provided with a corresponding well platform 16a, 16b, and 16c located at the surface of the corresponding one of the wells 14a, 14b, and 14c. As shown, the wells 14a, 14b, and 14c extend from the well platforms 16a, 16b, and 16c downwardly into the earth. However, it should be understood that, while the wells 14a, 14b, and 14c are shown over land, one or more of the wells 14a, 14b, and 14c may instead extend down from offshore platforms.

If desired, each of the wells 14a, 14b, and 14c may be divided into a plurality of separate branches, although one or more of the wells 14a, 14b, and 14c may instead comprise a single downwardly directed bore. In addition, it is possible to divide each of the wells 14a, 14b, and 14c into multiple zones that require separate or group monitoring and/or control for efficient production and management of the well.

A corresponding one of surface monitoring and control systems 20a, 20b, and 20c is provided on each of the well platforms 16a, 16b, and 16c. Down hole monitoring and control systems 22a1, 22a2, and 22a3 are provided within the well 14a, down hole monitoring and control system 22b is provided within the well 14b, and down hole monitoring and control systems 22c1 and 22c2 are provided within the well 14c. However, the wells 14a, 14b, and 14c may include fewer or more down monitoring and control systems than those shown in FIG. 1, and such down monitoring and control systems may be divided between any number of zones in each of the wells 14a, 14b, and 14c.

The surface monitoring and control system 20a is arranged to communicate with the down hole monitoring and control systems 22a1, 22a2, and 22a3 within the well 14a. Moreover, the surface monitoring and control system 20a mounted on the corresponding well platform 16a associated with the well 14a may be further arranged to communicate with the down hole monitoring and control systems 22b, 22c1, and 22c2 within the wells 14b and 14c in order to provide redundant monitoring and control of each of the wells 14a, 14b, and 14c from the surface. Likewise, the down hole monitoring and control system 22a1, 22a2, and 22a3 within the well 14a may be arranged to communicate with one another and with the down hole monitoring and control systems 22b, 22c1, and 22c2 within the wells 14b and 14c. Any of these communications may be unidirectional or bidirectional.

The surface monitoring and control system 20b is arranged to communicate with the down hole monitoring and control system 22b within the well 14b. Moreover, the surface monitoring and control system 20b mounted on the corresponding well platform 16b associated with the well 14b may be further arranged to communicate with the down hole monitoring and control systems 22a1, 22a2, 22a3, 22c1, and 22c2 within the wells 14a and 14c in order to provide redundant monitoring and control of each of the wells 14a, 14b, and 14c from the surface. Also, as should be understood from the above description, the down hole monitoring and control system 22b within the well 14b may be arranged to communicate with the down hole monitoring and control systems 22a1, 22a2, 22a3, 22c1, and 22c2 within the wells 14a and 14c. Again, any of these communications may be unidirectional or bidirectional.

Similarly, the surface monitoring and control system 20c is arranged to communicate with the down hole monitoring and control systems 22c1 and 22c2 within the well 14c. Moreover, the surface monitoring and control system 20c mounted on the corresponding well platform 16c associated with the well 14c may be further arranged to communicate with the down hole monitoring and control systems 22a1, 22a2, 22a3, and 22b within the wells 14a and 14b in order to provide redundant monitoring and control of each of the wells 14a, 14b, and 14c from the surface. Likewise, the down hole monitoring and control system 22c1 and 22c2 within the well 14c may be arranged to communicate with one another and with the down hole monitoring and control systems 22a1, 22a2, 22a3, and 22b within the wells 14a and 14b. Yet again, any of these communications may be unidirectional or bidirectional.

Furthermore, the surface monitoring and control systems 20a, 20b, and 20c mounted on the well platforms 16a, 16b, and 16c may be arranged to communicate with one another. In this case, the surface monitoring and control systems 20a, 20b, and 20c may communicate with one another using cellular transmissions, satellite transmission, telephone lines, and/or the like.

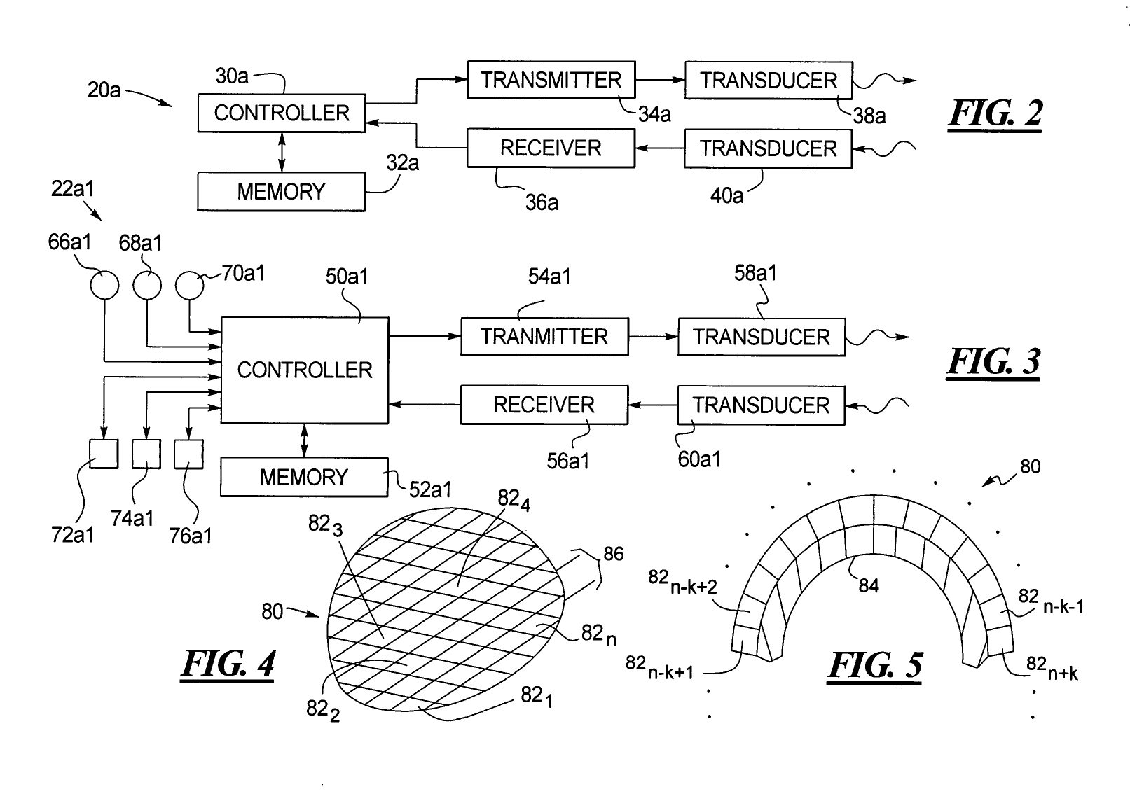

A representative one of the surface monitoring and control systems 20a, 20b, and 20c is shown in FIG. 2. In the specific case of FIG. 2, the surface monitoring and control system 20a is shown in additional detail. However, it should be understood that apparatus similar to that shown in FIG. 2 can be used to construct the other surface monitoring and control systems 20b and 20c.

The surface monitoring and control system 20a includes a controller 30a, a memory 32a, a transmitter 34a, a receiver 36a, a transducer 38a, and a transducer 40a. The controller 30a, for example, may be a microprocessor programmed to acquire (receive) sensor and/or logging information from one or more of the down hole monitoring and control systems 22a1, 22a2, and 22a3 within its corresponding well 14a. As discussed above, the controller 30a may also be arranged to acquire sensor and/or logging information from the down hole monitoring and control systems 22b, 22c1, and 22c2 within the wells 14b and 14c. The controller 30a may further be arranged to communicate (transmit) control information to one or more of the down hole monitoring and control systems 22a1, 22a2, and 22a3 within its corresponding well 14a and to the down hole monitoring and control systems 22b, 22c1, and 22c2 within the wells 14b and 14c. In addition, the controller 30a may be arranged to communicate control information to, and/or receive sensor and/or logging information from, the surface monitoring and control systems 20b and 20c and the remote central control center 12.

The controller 30a controls the transmitter 34a to transmit information to the down hole monitoring and control systems 22a1, 22a2, and 22a3 associated with the well 14a and to the down hole monitoring and control systems 22b, 22c1, and 22c2 within the wells 14b and 14c. The controller 30a may employ any addressing scheme to transmit this information to a specific one or group of the down hole monitoring and control systems 22a1, 22a2, 22a3, 22b, 22c1, and 22c2. One or more additional transmitters (not shown) may be provided to permit the controller 30a to transmit information to the surface monitoring and control systems 20b and 20c on the other well platforms 16b and 16c and to the remote central control center 12.

The transducer 38a converts the electrical signals from the transmitter 34a to acoustic signals, and the acoustic signals are then directed (steered) by the transducer 38a through the well and/or earth in a selected direction. These acoustic signals convey information to the desired destination. The transducer 38a, for example, may incorporate a plurality of electrical/acoustic converters, such as piezoelectric devices, that are selectively activated to convert an electrical signal to an acoustic signal and to direct the acoustic signal in a selected direction depending on the location of the particular receiver to which a communication is directed. For example, the controller 30a of the surface monitoring and control system 20a may selectively operate the transducer 38a to direct an acoustic signal toward the down hole monitoring and control system 22a1 in its associated well 14a, or toward one of the down hole monitoring and control systems 22a2 and 22a3 in its associated well 14a, or toward one of the down hole monitoring and control systems 22b, 22c1, or 22c2 associated with another one of the wells 14b or 14c.

The transducer 40a converts the electrical signals from the down hole monitoring and control systems 22a1, 22a2, 22a3, 22b, 22c1, and 22c2 to electrical signals for processing by the receiver 36a and the controller 30a. As before, these acoustic signals convey information from a source transmitter. The transducer 40a, for example, may incorporate a plurality of electrical/acoustic converters, such as piezoelectric devices, that are selectively activated to convert a received acoustic signal into an electrical signal and to have a selected or preferred direction of maximum sensitivity to a received acoustic signal depending on the geographic location of the particular transmitter from which a communication is to be received. For example, the controller 30a of the surface monitoring and control system 20a may select ones of the electrical/acoustic converters of the transducer 40a to receive acoustic energy primarily from the down hole monitoring and control system 22a1 in the well 14a, of from one of the other down hole monitoring and control systems 22a2 or 22a3 in the well 14a, or from one of the down hole monitoring and control systems 22b, 22c1, or 22c2 in one of the wells 14b or 14c.

The memory 32a stores a combination of the electrical/acoustic converters of the transducer 38a that should be activated in order for the acoustic energy emitted by the transducer 38a to be steered or directed toward a desired destination device.

For example, the memory 32a stores a first combination of one or more of the electrical/acoustic converters of the transducer 38a that should be activated in order to steer an acoustic signal from the surface monitoring and control system 20a to the down hole monitoring and control system 22a1. The memory 32a stores a second combination of one or more of the electrical/acoustic converters of the transducer 38a that should be activated in order to steer an acoustic signal from the surface monitoring and control system 20a to the down hole monitoring and control system 22b. The memory 32a stores a third combination of one or more of the electrical/acoustic converters of the transducer 38a that should be activated in order to steer an acoustic signal from the surface monitoring and control system 20a to the down hole monitoring and control system 22c1. The memory 32a stores additional combinations of one or more of the electrical/acoustic converters of the transducer 38a that should be activated in order to steer an acoustic signal from the surface monitoring and control system 20a to the other down hole monitoring and control systems 22a2, 22a3, and 22c2. Likewise, the memories in the surface monitoring and control systems 20b and 20c store combinations of one or more of the electrical/acoustic converters of the corresponding transmitting transducers that should be activated in order to steer an acoustic signal from the surface monitoring and control systems 20b and 20c to each of the down hole monitoring and control systems 22a1, 22a2, 22a3, 22b, 22c1, and 22c2 in the wells 14a, 14b, and 14c.

Similarly, the memory 32a stores a combination of the electrical/acoustic converters of the transducer 40a that should be gated in order for the transducer 40a to have a preferred directionality with respect to an acoustic signal transmitted by a source device. For example, the memory 32a stores a first combination of one or more of the electrical/acoustic converters of the transducer 40a that should be gated in order for the transducer 40a to have a preferred directionality with respect to an acoustic signal transmitted by the down hole monitoring and control system 22a1. The memory 32a stores a second combination of one or more of the electrical/acoustic converters of the transducer 40a that should be gated in order for the transducer 40a to have a preferred directionality with respect to an acoustic signal transmitted by the down hole monitoring and control system 22b. The memory 32a stores a third combination of one or more of the electrical/acoustic converters of the transducer 40a that should be gated in order for the transducer 40a to have a preferred directionality with respect to an acoustic signal transmitted by the down hole monitoring and control system 22c1. The memory 32a stores additional combinations of one or more of the electrical/acoustic converters of the transducer 40a that should be gated in order for the transducer 40a to have a preferred directionality with respect to an acoustic signal transmitted by the other down hole monitoring and control systems 22a2, 22a3, and 22c2. Likewise, the memories in the surface monitoring and control systems 20b and 20c store combinations of one or more of the electrical/acoustic converters of the corresponding receiving transducers that should be gated in order for the transducer 40a to have a preferred directionality with respect to an acoustic signal transmitted by each of the down hole monitoring and control systems 22a1, 22a2, 22a3, 22b, 22c1, and 22c2 in the wells 14a, 14b, and 14c.

A representative one of the down hole monitoring and control systems 22a1, 22a2, 22a3, 22b, 22c1, and 22c2 is shown in FIG. 3. In the specific case of FIG. 2, the down hole monitoring and control system 22a1 is shown in additional detail. However, it should be understood that apparatus similar to that shown in FIG. 3 can be used to construct the other down hole monitoring and control systems 22a2, 22a3, 22b, 22c1, and 22c2.

The down hole monitoring and control system 22a1 includes a controller 50a1, a memory 52a1, a transmitter 54a1, a receiver 56a1, a transducer 58a1, and a transducer 60a1. The controller 50a1, for example, may be a microprocessor programmed to transmit sensor and/or logging information to the surface monitoring and control system 20a. The controller 50a1 may also be arranged to transmit sensor and/or logging information to the surface monitoring and control systems 20b and 20c at the wells 14b and 14c. The controller 50a1 further may be arranged to transmit sensor and/or logging information to other down hole monitoring and control systems 22a2, 22a3, 22b, 22c1, and 22c2.

Moreover, the controller 50a1 may be arranged to receive control messages from the surface monitoring and control system 20a at its corresponding well 14a and from the surface monitoring and control systems 20b and 20c at the wells 14b and 14c, and the controller 50a1 may further be arranged to receive sensor and/or logging information and/or control messages from the down hole monitoring and control systems 22a2, 22a3, 22b, 22c1, and 22c2.

The controller 50a1 controls the transmitter 54a1 to transmit messages to the surface monitoring and control systems 20a, 20b, and 20c and to the down hole monitoring and control systems 22a2, 22a3, 22b, 22c1, and 22c2. The controller 50a1 may employ any addressing scheme, such as those described above, to transmit information to a specific one or group of destinations.

The transducer 58a1 converts the electrical signals from the transmitter 54a1 to acoustic signals and steers the acoustic signals through the well and/or earth. These acoustic signals convey information to the desired destination. The transducer 58a1, for example, may incorporate a plurality of electrical/acoustic converters, such as piezoelectric devices, that that are selectively activated to convert an electrical signal to an acoustic signal and to steer the acoustic signal in a selected direction depending on the location of the particular receiver to which a communication message is directed. For example, the controller 50a1 of the down hole monitoring and control system 22a1 may selectively operate the electrical/acoustic converters of the transducer 58a1 to steer an acoustic signal toward the surface monitoring and control system 20a of its associated well 14a, or toward one of the down hole monitoring and control systems 22a2, 22a3, 22b, 22c1, or 22c2, or toward one of the surface monitoring and control systems 20b and 20c of the wells 14b and 14c.

The transducer 60a1 converts the acoustic signals transmitted by source devices to corresponding electrical signals for processing by the receiver 56a1 and the controller 50a1. The transducer 60a1, for example, may incorporate a plurality of electrical/acoustic converters, such as piezoelectric devices, that are selectively gated to the receiver 56a1 to convert an acoustic signal to an electrical signal and to have a selected direction of maximum sensitivity to an acoustic signal depending on the particular transmitter from which the acoustic signal is to be received. For example, the controller 50a1 of the down hole monitoring and control system 22a1 may select ones of the electrical/acoustic converters of the transducer 60a1 to receive acoustic energy from the surface monitoring and control systems 20a, from the down hole monitoring and control systems 22a2, 22a3, 22b, 22c1, and 22c2, or from one of the surface monitoring and control systems 20b and 20c.

The memory 52a1 stores a combination of one or more of the electrical/acoustic converters of the transducer 58a1 that should be gated to the receiver 56a1 so that the acoustic energy emitted by the transducer 58a1 is directed or steered toward a destination device.

For example, the memory 52a1 stores a first combination of one or more of the electrical/acoustic converters of the transducer 58a1 that should be activated in order to steer an acoustic signal from the down hole monitoring and control system 22a1 to the surface monitoring and control system 20a. The memory 52a1 stores a second combination of one or more of the electrical/acoustic converters of the transducer 58a1 that should be activated in order to steer an acoustic signal from the down hole monitoring and control system 22a1 to the down hole monitoring and control system 22b. The memory 52a1 stores a third combination of one or more of the electrical/acoustic converters of the transducer 58a1 that should be activated in order to steer an acoustic signal from the down hole monitoring and control system 22a1 to the down hole monitoring and control system 22c1.

Assuming that the surface monitoring and control system 20a and the down hole monitoring and control systems 22b and 22c1 do not have a common axis, the first, second, and third combination of one or more of the electrical/acoustic converters of the transducer 58a1 should be different subsets.

The memory 52a1 stores additional combinations of one or more of the electrical/acoustic converters of the transducer 58a1 that should be activated in order to steer an acoustic signal from the down hole monitoring and control system 22a1 to the other down hole monitoring and control systems 22a2, 22a3, and 22c2, and to the other surface monitoring and control systems 20b and 20c. Likewise, the memories in the down hole monitoring and control systems 22a2, 22a3, 22b, 22c1, and 22c2 store combinations of one or more of the electrical/acoustic converters of their transducers that should be activated in order to steer acoustic signals from the down hole monitoring and control systems 22a2, 22a3, 22b, 22c1, and 22c2 to each other, to the down hole monitoring and control system 22a1, and to the surface monitoring and control systems 20a, 20b, and 20c.

The memory 52a1 further stores combinations of one or more of the electrical/acoustic converters of the transducer 60a1 that should be gated to the receiver 56a1 so that the acoustic energy of an acoustic signal to be received by the down hole monitoring and control system 22a1 is received with increased sensitivity.

For example, the memory 52a1 stores a first combination of one or more of the electrical/acoustic converters of the transducer 60a1 that should be gated in order for the transducer 60a1 to have a preferred directionality with respect to an acoustic signal transmitted by the surface monitoring and control system 20a. The memory 52a1 stores a second combination of one or more of the electrical/acoustic converters of the transducer 60a1 that should be gated in order for the transducer 60a1 to have a preferred directionality with respect to an acoustic signal transmitted by the down hole monitoring and control system 22b. Likewise, the memory 52a1 stores a third combination of one or more of the electrical/acoustic converters of the transducer 60a1 that should be gated in order for the transducer 60a1 to have a preferred directionality with respect to an acoustic signal transmitted by the down hole monitoring and control system 22c1.

Assuming that the surface monitoring and control system 20a and the down hole monitoring and control systems 22b and 22c1 do not have a common axis, the first, second, and third combinations should be different.

Similarly, the memory 52a1 stores additional combinations of one or more of the electrical/acoustic converters of the transducer 60a1 that should be gated in order for the transducer 60a1 to have a preferred directionality with respect to acoustic signals transmitted by the other down hole monitoring and control systems 22a2, 22a3, and 22c2 and by the other surface monitoring and control systems 20b and 20c. Likewise, the memories in the down hole monitoring and control systems 22a2, 22a3, 22b, 22c1, and 22c2 store combinations of one or more of the electrical/acoustic converters of their corresponding receiver transducers that should be gated in order for these transducers to have a preferred directionality with respect to acoustic signals transmitted by each other, by the down hole monitoring and control system 22a1, and by the surface monitoring and control systems 20a, 20b, and 20c.

The controller 50a1 may be programmed to acquire and log sensor information from sensors 66a1, 68a1, and 70a1 located in the well 14a. The sensors 66a1, 68a1, and 70a1 may be selected to sense pertinent conditions within the down hole of the well 14a. For example, the sensor 66a1 may be a pressure sensor, the sensor 68a1 may be a temperature sensor, and the sensor 70a1 may be a flow sensor. Different, fewer, or additional sensors may be provided to sense the same and/or other conditions within the corresponding zone or well.

The controller 50a1 may also be arranged to perform control operations within the down hole of the well 14a. Therefore, the controller 50a1 may also be coupled to a valve 72a1, a pump 74a1, and/or another type of electromechanical device 76a1 as may be necessary to implement the desired control functions. Different, fewer, or additional actuators may be provided to control the same and/or other control functions within the corresponding zone or well.

The memory 52a1 of the down hole monitoring and control system 22a1 stores the sensor and logging information. The memory 52a1 also stores the communication programming necessary to transmit the sensor and log information to other devices and to received control messages and other communications from other devices. The memory 52a1 further stores the control programming necessary to perform the required control functions.

FIGS. 4 and 5 illustrate, by way of example, a transducer 80 that can be used for each of the transducers 38a, 40a, 58a1, and 60a1 such that a first instantiation of the transducer 80 is used for the transducer 38a, a second instantiation of the transducer 80 is used for the transducer 40a, a third instantiation of the transducer 80 is used for the transducer 58a1, and a fourth instantiation of the transducer 80 is used for the transducer 60a1.

The transducer 80 includes a plurality of individually controllable electrical/acoustic converters 82₁, 82₂, 82₃, 82₄, . . . , 82ₙ arranged in a grid-like fashion around a substrate 84. As shown by the cross-sectional diagram of FIG. 5, the substrate is a dome or half sphere. However, the substrate 84 can alternatively be a sphere or two half spheres together forming a sphere, except for openings that permit electrical control lines 86 to connect to the individually controllable electrical/acoustic converters 82₁, 82₂, 82₃, 82₄, . . . , 82ₙ. The spherical shape of the transducer 80 permits the acoustic signals emitted by the transducer 80 to be three dimensionally steered in any direction. However, the substrate 84 on which the individually controllable electrical/acoustic converters 82₁, 82₂, 82₃, 82₄, . . . , 82ₙ are mounted may have any desired geometric shape. Moreover, the individually controllable electrical/acoustic converters 82₁, 82₂, 82₃, 82₄, . . . , 82ₙ may be controlled in groups instead of individually.

The transducer 38a can be trained to steer acoustic signals to each of the down hole monitoring and control systems 22a1, 22a2, 22a3, 22b, 22c1, and 22c2. Also, the transducer 40a can be trained to have a preferred directionality with respect to acoustic signals transmitted by the down hole monitoring and control systems 22a1, 22a2, 22a3, 22b, 22c1, and 22c2.

For example, during set up at the time of installation, various combinations of one or more of the electrical/acoustic converters 82₁, 82₂, 82₃, 82₄, . . . , 82ₙ of the transducer 38a are activated by the controller 30a to steer an acoustic signal from the transmitter 34a toward the down hole monitoring and control system 22a1. The combination of the electrical/acoustic converters 82₁, 82₂, 82₃, 82₄, . . . , 82ₙ of the transducer 38a that produces the best reception of this acoustic signal at the down hole monitoring and control system 22a1 is stored in the memory 32a as the combination of the electrical/acoustic converters 82₁, 82₂, 82₃, 82₄, . . . , 82ₙ of the transducer 38a to be used when communicating messages to the down hole monitoring and control system 22a1 from the surface monitoring and control system 20a.

Similarly, various combinations of one or more of the electrical/acoustic converters 82₁, 82₂, 82₃, 82₄, . . . , 82ₙ of the transducer 40a are gated to the receiver 36a while the down hole monitoring and control system 22a1 is emitting an acoustic signal. The combination of the electrical/acoustic converters 82₁, 82₂, 82₃, 82₄, . . . , 82ₙ of the transducer 40a that produces the best reception by the receiver 36a of the acoustic signal from the down hole monitoring and control system 22a1 is stored in the memory 32a as the combination of the electrical/acoustic converters 82₁, 82₂, 82₃, 82₄, . . . , 82ₙ of the transducer 40a to be used when receiving communication messages by the receiver 36a of the surface monitoring and control system 20a from the down hole monitoring and control system 22a1.

Also, various combinations of one or more of the electrical/acoustic converters 82₁, 82₂, 82₃, 82₄, . . . , 82ₙ of the transducer 38a are activated by the controller 30a to steer an acoustic signal from the transmitter 34a toward the down hole monitoring and control system 22b. The combination of the electrical/acoustic converters 82₁, 82₂, 82₃, 82₄, . . . , 82ₙ making up the transducer 38a that produces the best reception of this acoustic signal at the down hole monitoring and control system 22b is stored in the memory 32a as the combination of the electrical/acoustic converters 82₁, 82₂, 82₃, 82₄, . . . , 82ₙ of the transducer 38a to be used when communicating messages from the surface monitoring and control system 20a to the down hole monitoring and control system 22b.

Similarly, various combinations of one or more of the electrical/acoustic converters 82₁, 82₂, 82₃, 82₄, . . . , 82ₙ of the transducer 40a are gated to the receiver 36a while the down hole monitoring and control system 22b is emitting an acoustic signal. The combination of the electrical/acoustic converters 82₁, 82₂, 82₃, 82₄, . . . , 82ₙ of the transducer 40a that produces the best reception by the receiver 36a of the acoustic signal from down hole monitoring and control system 22b is stored in the memory 32a as the combination of the electrical/acoustic converters 82₁, 82₂, 82₃, 82₄, . . . , 82ₙ of the transducer 40a to be used when receiving communication messages by the receiver 36a of the surface monitoring and control system 20a from the down hole monitoring and control system 22b.

This process is repeated so that the memory 32a stores a combination of the electrical/acoustic converters 82₁, 82₂, 82₃, 82₄, . . . , 82ₙ of the transducer 38a that produces the best reception by each of the other down hole monitoring and control systems 22a2, 22a3, 22c1, and 22c2 of an acoustic signal transmitted by the surface monitoring and control system 20a, and so that the memory 32a stores a combination of the electrical/acoustic converters 82₁, 82₂, 82₃, 82₄, . . . , 82ₙ of the transducer 40a that produces the best reception of acoustic signals received by the receiver 36a of the surface monitoring and control system 20a from the other down hole monitoring and control systems 22a2, 22a3, 22c1, and 22c2.

This process is further repeated so that the memories of the surface monitoring and control systems 20b and 20c store combinations of one or more of the electrical/acoustic converters 82₁, 82₂, 82₃, 82₄, . . . , 82ₙ of their transmitting transducers that produce the best reception by the down hole monitoring and control systems 22a1, 22a2, 22a3, 22b, 22c1, and 22c2 of acoustic signals transmitted by the surface monitoring and control systems 20b and 20c, and so that the memories of the surface monitoring and control systems 20b and 20c store combinations of one or more of the electrical/acoustic converters 82₁, 82₂, 82₃, 82₄, . . . , 82ₙ of their receiving transducers that produce the best reception by the surface monitoring and control systems 20b and 20c of acoustic signals transmitted by down hole monitoring and control systems 22a1, 22a2, 22a3, 22b, 22c1, and 22c2.

Likewise, the transducer 58a1 can be trained to steer acoustic signals to each of the down hole monitoring and control systems 22a2, 22a3, 22b, 22c1, and 22c2 and to each of the surface monitoring and control systems 20a, 20b, and 20c. Also, the transducer 60a1 can be trained to have a preferred directionality with respect to acoustic signals transmitted by the down hole monitoring and control systems 22a1, 22a2, 22a3, 22b, 22c1, and 22c2 and by the surface monitoring and control systems 20a, 20b, and 20c.

For example, during set up at the time of installation, various combinations of one or more of the electrical/acoustic converters 82₁, 82₂, 82₃, 82₄, . . . , 82ₙ of the transducer 58a1 are activated by the controller 50a1 to steer an acoustic signal from the transmitter 54a1 toward the surface monitoring and control system 20a. The combination of the electrical/acoustic converters 82₁, 82₂, 82₃, 82₄, . . . , 82ₙ of the transducer 58a1 that produces the best reception of this acoustic signal at the surface monitoring and control system 20a is stored in the memory 52a1 as the combination of the electrical/acoustic converters 82₁, 82₂, 82₃, 82₄, . . . , 82ₙ of the transducer 58a1 to be used when communicating messages to the surface monitoring and control system 20a from the down hole monitoring and control system 22a1.

Similarly, various combinations of one or more of the electrical/acoustic converters 82₁, 82₂, 82₃, 82₄, . . . , 82ₙ of the transducer 60a1 are gated to the receiver 56a1 while the surface monitoring and control system 20a is emitting an acoustic signal. The combination of the electrical/acoustic converters 82₁, 82₂, 82₃, 82₄, . . . , 82ₙ of the transducer 60a1 that produces the best reception by the receiver 56a1 of the acoustic signal from the surface monitoring and control system 20a is stored in the memory 52a1 as the combination of the electrical/acoustic converters 82₁, 82₂, 82₃, 82₄, . . . , 82ₙ of the transducer 60a1 to be used when receiving communication messages by the receiver 56a1 of the down hole monitoring and control system 22a1 from the surface monitoring and control system 20a.

Also, various combinations of one or more of the electrical/acoustic converters 82₁, 82₂, 82₃, 82₄, . . . , 82, of the transducer 58a1 are activated by the controller 50a1 to steer an acoustic signal from the transmitter 54a1 toward the down hole monitoring and control system 22b. The combination of the electrical/acoustic converters 82₁, 82₂, 82₃, 82₄, . . . , 82ₙ making up the transducer 58a1 that produces the best reception of this acoustic signal at the down hole monitoring and control system 22b is stored in the memory 52a1 as the combination of the electrical/acoustic converters 82₁, 82₂, 82₃, 82₄, . . . , 82ₙ of the transducer 58a1 to be used when communicating messages from the down hole monitoring and control system 22a1 to the down hole monitoring and control system 22b.

Similarly, various combinations of one or more of the electrical/acoustic converters 82₁, 82₂, 82₃, 82₄, . . . , 82ₙ of the transducer 60a1 are gated to the receiver 56a1 while the down hole monitoring and control system 22b is emitting an acoustic signal. The combination of the electrical/acoustic converters 82₁, 82₂, 82₃, 82₄, . . . , 82ₙ of the transducer 60a1 that produces the best reception by the receiver 56a1 of the acoustic signal from down hole monitoring and control system 22b is stored in the memory 52a1 as the combination of the electrical/acoustic converters 82₁, 82₂, 82₃, 82₄, . . . , 82ₙ of the transducer 60a1 to be used when receiving communication messages by the receiver 56a1 of the down hole monitoring and control system 22a1 from the down hole monitoring and control system 22b.

This process is repeated so that the memory 52a1 stores a combination of the electrical/acoustic converters 82₁, 82₂, 82₃, 82₄, . . . , 82ₙ of the transducer 58a1 that produces the best reception by each of the other down hole monitoring and control systems 22a2, 22a3, 22c1, and 22c2 and by each of the other surface monitoring and control systems 20b and 20c of an acoustic signal transmitted by the down hole monitoring and control system 22a1, and so that the memory 52a1 stores a combination of the electrical/acoustic converters 82₁, 82₂, 82₃, 82₄, . . . , 82ₙ of the transducer 60a1 that produces the best reception of acoustic signals received by the receiver 56a1 of the down hole monitoring and control system 22a1 from the other down hole monitoring and control systems 22a2, 22a3, 22c1, and 22c2 and the other surface monitoring and control systems 20b and 20c.

This process is further repeated so that the memories of the down hole monitoring and control systems 22a2, 22a3, 22b, 22c1, and 22c2 store combinations of one or more of the electrical/acoustic converters 82₁, 82₂, 82₃, 82₄, . . . , 82ₙ of their transmitting transducers that produce the best reception by each other, by the down hole monitoring and control system 22a1, and by the surface monitoring and control systems 20a, 20b, and 20c of acoustic signals transmitted by the down hole monitoring and control systems 22a2, 22a3, 22b, 22c1, and 22c2, and so that the memories of the down hole monitoring and control systems 22a2, 22a3, 22b, 22c1, and 22c2 store combinations of one or more of the electrical/acoustic converters 82₁, 82₂, 82₃, 82₄, . . . , 82ₙ of their receiving transducers that produce the best reception by the down hole monitoring and control systems 22a2, 22a3, 22b, 22c1, and 22c2 of acoustic signals transmitted by the down hole monitoring and control system 22a1, by each other, and by the surface monitoring and control systems 20a, 20b, and 20c.

Certain modifications of the present invention have been discussed above. Other modifications will occur to those practicing in the art of the present invention. For example, the surface monitoring and control systems and the down hole monitoring and control systems are provided with both transmitters and receivers in order to both transmit and receive signals. However, any of the surface monitoring and control systems and the down hole monitoring and control systems may be provided with only a transmitter or only a receiver if it is desired that the corresponding system only transmit or receive signals.

Also, although the surface monitoring and control systems and the down hole monitoring and control systems are provided with separate transmitters and receivers, the transmitter and receiver of one or more of the surface monitoring and control systems and the down hole monitoring and control systems may be replaced by a corresponding transceiver.

Moreover, although the surface monitoring and control systems and the down hole monitoring and control systems are provided with a separate transducer for each of the transmitters and receivers, a single transducer may be provided for each transmitter/receiver pair or for a transceiver used in place of a transmitter/receiver pair.

Furthermore, although transmitters and receivers are shown and described as devices that are separate from the corresponding controllers, it should be understood that the functions of the transmitters and receivers may be performed by the controllers. In that case, the controllers may be coupled directly to the transducers, or the controllers may be coupled to the transducers through other devices such as A/D and D/A converters, and/or multiplexers, and/or the like.

In addition, each of the wells as described above is provided with a corresponding one of the surface monitoring and control systems. However, fewer surface monitoring and control systems may be used so that one or more of the surface monitoring and control systems covers more than one of the wells.

Also, the remote central control center may be arranged to control all of the wells in an entire field or in multiple fields. Alternatively, one or more of the surface monitoring and control systems may be arranged to control all of the wells in an entire field or in multiple fields. As a further alternative, the remote central control center may be eliminated and the fields may be divided up among multiple ones of the surface monitoring and control systems, or all fields may be controlled from a single surface monitoring and control system.

Moreover, each of the surface monitoring and control systems is shown with a controller and each of the down hole monitoring and control systems is shown with a controller. Alternatively, it is possible to operate the surface monitoring and control systems and the down hole monitoring and control systems without controllers.

Furthermore, the electrical/acoustic converters 82₁, 82₂, 82₃, 82₄, . . . , 82ₙ may be individually moved or positioned relative to the substrate 84 to alternatively or additionally steer the transmission or reception of acoustic signals. For, example, electrostatic positioning can be used for this purpose

Accordingly, the description of the present invention is to be construed as illustrative only and is for the purpose of teaching those skilled in the art the best mode of carrying out the invention. The details may be varied substantially without departing from the spirit of the invention, and the exclusive use of all modifications which are within the scope of the appended claims is reserved.

We claim:

1. A communication device associated with a well comprising:
a transducer arranged to convert an electrical signal to an acoustic signal; and,
a controller coupled to the transducer, wherein the controller is arranged to control the transducer so as to steer the acoustic signal through the well toward a receiving device.

2. The communication device of claim 1 wherein the transducer includes a plurality of electrical/acoustic converters, and wherein the controller is arranged to control one or more of the electrical/acoustic converters so as to steer the acoustic signal toward the receiving device.

3. The communication device of claim 2 wherein the controller includes a memory that stores a combination of the electrical/acoustic converters that are used to steer the acoustic signal toward the receiving device, and wherein the controller controls the electrical/acoustic converters in accordance with the stored combination so as to steer the acoustic signal toward the receiving device.

4. The communication device of claim 2 wherein a position of each of the electrical/acoustic converters is controllable.

5. The communication device of claim 2 wherein a position of each of the electrical/acoustic converters is electrostatically controllable.

6. The communication device of claim 2 wherein the electrical/acoustic converters comprises corresponding piezoelectric devices.

7. The communication device of claim 1 wherein the controller includes a transmitter that supplies the electrical signal to the transducer.

8. The communication device of claim 1 further comprising at least one sensor coupled to the controller.

9. The communication device of claim 1 further comprising at least one electromechanical device controlled by the controller.

10. The communication device of claim 1 wherein the transducer and controller have a down hole location, and wherein the receiving device has a surface location.

11. The communication device of claim 1 wherein the transducer and controller have a surface location, and wherein the receiving device has a down hole location.

12. The communication device of claim 1 wherein the transducer and controller have a down hole location, and wherein the receiving device has a down hole location.

13. A communication device associated with a well comprising:
a transducer arranged to receive an acoustic signal transmitted by a transmitting device and to convert the received acoustic signal to an electrical signal; and,
a controller coupled to the transducer, wherein the controller is arranged to control the transducer so that the transducer has a preferred directional sensitivity to the received acoustic signal.

14. The communication device of claim 13 wherein the transducer includes a plurality of electrical/acoustic converters, and wherein the controller is arranged to control one or more of the electrical/acoustic converters so that the transducer has the preferred directional sensitivity to the received acoustic signal.

15. The communication device of claim 14 wherein the controller includes a memory that stores a combination of the electrical/acoustic converters that are used to provide the transducer with the preferred directional sensitivity to the received acoustic signal, and wherein the controller controls the electrical/acoustic converters in accordance with the stored combination so that the transducer has the preferred directional sensitivity to the received acoustic signal.

16. The communication device of claim 14 wherein a position of each of the electrical/acoustic converters is controllable.

17. The communication device of claim 14 wherein a position of each of the electrical/acoustic converters is electrostatically controllable.

18. The communication device of claim 14 wherein the electrical/acoustic converters comprises corresponding piezoelectric devices.

19. The communication device of claim 13 wherein the controller includes a receiver that processes the electrical signal from the transducer.

20. The communication device of claim 13 further comprising at least one sensor coupled to the controller.

21. The communication device of claim 13 further comprising at least one electromechanical device controlled by the controller.

22. The communication device of claim 13 wherein the transducer and controller have a down hole location, and wherein the transmitting device has a surface location.

23. The communication device of claim 13 wherein the transducer and controller have a surface location, and wherein the transmitting device has a down hole location.

24. The communication device of claim 13 wherein the transducer and controller have a down hole location, and wherein the transmitting device has a down hole location.

25. A communication method comprising:
converting a signal between an electrical form and an acoustic form, wherein the converting is performed by a transducer of a first communication device; and,
controlling the transducer so that the transducer has a preferred directionality with respect to an acoustic signal transmitted between the first communication device and a second communication device.

26. The communication method of claim 25 wherein the transducer includes a plurality of electrical/acoustic converters, and wherein the communication method includes controlling one or more of the electrical/acoustic converters so as to realize the preferred directionality.

27. The communication method of claim 26 including storing a combination of the electrical/acoustic converters that are used to realize the preferred directionality, and controlling the electrical/acoustic converters in accordance with the stored combination so as to realize the preferred directionality.

28. The communication method of claim 26 wherein a position of each of the electrical/acoustic converters is controllable.

29. The communication method of claim 26 wherein a position of each of the electrical/acoustic converters is electrostatically controllable.

30. The communication method of claim 25 including providing sensor signals from a sensor.

31. The communication method of claim 25 comprising providing signals to at least one electromechanical device.

32. The communication method of claim 25 wherein the first communication device has a down hole location, and wherein the second communication device has a surface location.

33. The communication method of claim 25 wherein the first communication device has a surface location, and wherein the second communication device has a down hole location.

34. The communication method of claim 25 wherein the first communication device has a down hole location, and wherein the second communication device has a down hole location.
